(19) United States
(12) Patent Application Publication
(10) Pub. No.: US 2007/0177297 A1
(43) Pub. Date: Aug. 2, 2007

(54) APPARATUS AND METHOD FOR MULTIPLE DISKS STACKING AND DESTACKING

(75) Inventors: Kien Wee Lai, Singapore (SG); Chia Meng Chew, Singapore (SG); Jui Kiat Goh, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, omitted

(73) Assignee: LaserResearch (S) Pte Ltd, Singapore (SG)

(21) Appl. No.: 11/669,956

(22) Filed: Feb. 1, 2007

Related U.S. Application Data
(60) Provisional application No. 60/763,919, filed on Feb. 1, 2006.

(51) Int. Cl. G11B 17/02

(52) U.S. Cl. 360/99.12

(57) ABSTRACT

The present invention provides a disk stack assembly for processing a plurality of disks in a servowriter. The present invention further provides a servowriter system for processing multiple disks.

### RELATED APPLICATION

This application claims the benefit under 35 U.S.C. 119(e) of U.S. Provisional Application Ser. No. 60/763,919, filed 1 Feb. 2006, which is herein incorporated by reference.

### FIELD OF THE INVENTION

The present invention generally relates to servowriters and, more particularly apparatus and method for multiple disks stacking and destacking, and furthermore to an automatic clamp that can clamp a disk stack during processing.

### BACKGROUND OF THE INVENTION

A typical media servowriter comprises a hub and an air-bearing spindle motor with a rotating shaft, wherein the hub is attached to the spindle air bearing so that the hub can be rotated by the rotating shaft of the air-bearing spindle motor. Usually, the hub has the capacity of receiving a disk-stack with multiple disks and spacers. During servo-track writing, the rotary motion of the air-bearing spindle motor spins the hub and hence the disk-stack it carries. Each read-write head is attached to a head suspension device that is connected to an actuator arm. The actuator arm carrying the read-write heads are inserted in-between the disks while reading or writing on the disk surfaces. Thus, a media servowriter writes on multiple disks simultaneously.

Currently, a disk-stack with multiple disks and spacers for a media servowriter is assembled in two ways. The first one is that a fixed hub is machined and centered on the spindle air bearing so that the disk-stack is assembled piece-by-piece within the fixed hub on the servowriter. The advantage of this approach is that the disk-stack is reducing the off-balanced on the rotating mass as compare to removable spud. However, the local assembly of the disk-stack on the servowriter is time consuming so as to reduce the utilization of the servowriter.

The second way is that the media servowriter has a removable hub so that the disk-stack can be assembled on the removable hub outside of the media servowriter, then the removable hub with the disk-stack can be transferred to/from the media servowriter. The advantage of assembly of the disk-stack off-line increases the utilization of the media servowriter. In addition, this method can use one stacking/de-stacking mechanism for multiple media servowriters. However, the disadvantage is that an error may occur in centering the removable hub on the servowriter with the addition of centering error of individual disks on the hub when performed off-line. This creates a bigger miss registration of the tracks as wells as a larger imbalance-therefore more vibration-during the servowriting process.

The inventors of the present invention have disclosed a disk-stack assembly and transfer apparatus that allows multiple disks and spacers to be stacked by a stacker/de-stacker module before the disk-stack is transferred to a fixed hub or to be de-stacked after the disk-stack is removed from the fixed hub in U.S. patent application Ser. No. 11/420,471, filed on 25 May 2006 with a title of “Apparatus And Method For Disk-Stack Assembly And Transfer With Ta—C Coating To Reduce Metallic Particulates”, which is incorporated herein in its entirety.

Furthermore, stacking and de-stacking operation before and after media servowriting operation where servo data is written to the disks generates metallic particulates on disks. However, the requirement for particulate-free servo-written disks is crucial for reliable disk drive performance.

### SUMMARY OF THE INVENTION

One embodiment of the present invention provides a disk stack assembly for processing a plurality of disks in a servowriter. The disk stack assembly comprises a disk-stack with a plurality of disks and spacers, where the disks and spacers are alternately placed, and a bottom spacer and a top spacer are disposed at the two ends of the disk stack; a fixed hub upon which the disk stack is mounted for processing, where the fixed hub has a central chamber; and an automatic clamp disposed within the central chamber; thereby when the disk stack is mounted onto the fixed hub, the automatic clamp clamps the disk stack to secure the disk stack through the processing.

Another embodiment of the disk stack assembly, it further comprises a clock nut; and a clock disk secured by the clock nut; where the clock nut and the clock disk are disposed below the bottom spacer.

Another embodiment of the disk stack assembly, the automatic clamp is configured to have a cylindrical body with a first end and a second end; where a first end with a plurality of fingers, where each finger has a ramp; where a second end with a clamp bottom surface for contacting with the fixed hub, a hub seal groove at the outside of the second end, and a hard-stop area and a spring shaft seal groove inside of the second end; and where the cylindrical body has a plurality of slots that are equal to the number of fingers; thus the fingers are flexible to be bent when they ride on the ramp.

Another embodiment of the servowriter system, said disk stack assembly further comprises an air actuation mechanism for controlling the open/close switch of the automatic clamp; where the air actuation mechanism comprises a spring shaft, and a spring disposed within the automatic clamp; and where the spring shaft is fixed to the hub to allow the automatic clamp move up/down within the fixed hub, and the spring can be compressed by an external pressurized air supply so that the supply or loss of supply of the external pressurized air, the spring can hold the disk stack; thereby the spring and the pressurized air are translated into the open/close of the automatic clamp.

Another embodiment of the disk stack assembly, the spring shaft has a spring rested shoulder, a shaft body for compression spring, a hard-stop shoulder for preventing the automatic clamp from over travel, an air passage communicable with the external pressurized air supply, an air outlet and a male thread to secure the spring shaft to the hub.

Another embodiment of the disk stack assembly, the fixed hub has a hub nose; a hub shaft; and a hub base; wherein the hub nose is configured to have a smaller dimension that that of the hub shaft to reduce the contact of the disks with the fixed hub; wherein the hub shaft is configured to have a central hollow for receiving the automatic clamp and allowing the communication of the automatic clamp with an external actuation mechanism; and wherein the hub base is configured to receive the disk stack and other additional components.

Another embodiment of the present invention provides a servowriter system for processing multiple disks. The servowriter system comprises an offline stacking/destacking module for assembling or disassembling a disk stack with a plurality of disks and spacers; a fixed hub upon which a disk stack assembly is assembled for processing; a gripper module for holding the disk stack during transport; and a transporter module operably connected to the gripper module so that the disk stack can be transported from the offline stacking/destacking module to the fixed hub or vice versa.

Another embodiment of the servowriter system, it further comprises an E-block for providing actuating arms for read/write heads; and a positioner for positioning the E-block onto the disk stack from the fixed hub when the processing is ready.

Another embodiment of the servowriter system, the offline stacking/destacking module comprises a removable spud that is configured to have an automatic clamp for holding the assembled disk stack in place; a body for disk assembly; and an interface portion for positioning the removable spud; an automatic clamp for clamping the assembled disk stack; and a clamping mechanism for holding and positioning the removable spud.

Another embodiment of the servowriter system, the disk stack assembly comprises the disk-stack with a plurality of disks and spacers, where the disks and spacers are alternately placed, and a bottom spacer and a top spacer are disposed at the two ends of the disk stack; the fixed hub upon which the disk stack is mounted for processing, where the fixed hub has a central chamber; and an automatic clamp disposed within the central chamber; thereby when the disk stack is mounted onto the fixed hub, the automatic clamp clamps the disk stack to secure the disk stack through the processing.

Another embodiment of the servowriter system, the disk stack assembly further comprises a clock nut; and a clock disk secured by the clock nut; where the clock nut and the clock disk are disposed below the bottom spacer.

Another embodiment of the servowriter system, the automatic clamp is configured to have a cylindrical body with a first end and a second end; where a first end with a plurality of fingers, where each finger has a ramp; where a second end with a clamp bottom surface for contacting with the fixed hub, a hub seal groove at the outside of the second end, and a hard-stop area and a spring shaft seal groove inside of the second end; and where the cylindrical body has a plurality of slots that are equal to the number of fingers; thus the fingers are flexible to be bent when they ride on the ramp.

Another embodiment of the servowriter system, said disk stack assembly further comprises an air actuation mechanism for controlling the open/close switch of the automatic clamp.

Another embodiment of the servowriter system, the spring shaft has a spring rested shoulder, a shaft body for compression spring, a hard-stop shoulder for preventing the automatic clamp from over travel, an air passage communicable with the external pressurized air supply, an air outlet and a male thread to secure the spring shaft to the hub.

Another embodiment of the servowriter system, the fixed hub has a hub nose; a hub shaft; and a hub base; wherein the hub nose is configured to have a smaller dimension that that of the hub shaft to reduce the contact of the disks with the fixed hub; wherein the hub shaft is configured to have a central hollow for receiving the automatic clamp and allowing the communication of the automatic clamp with an external actuation mechanism; and wherein the hub base is configured to receive the disk stack and other additional components.

Another embodiment of the servowriter system, the bottom spacer has an outer groove for being used for gripping during the transport of the disk stack.

Another embodiment of the servowriter system, the gripper module comprises a pair of gripper fingers, a pair of gripper connecting rods, a pair of actuation cylinders, and a disk stack holder; where the gripper connecting rods integrally connect the gripper fingers and the actuation cylinders so that the grippers fingers can be controlled by the actuation cylinders.

Another embodiment of the servowriter system, the gripper finger comprises a pair of gripping tips and a gripping guide.

Another embodiment of the servowriter system, it further comprises an air damper for reducing the vibration of the system.

The objectives and advantages of the invention will become apparent from the following detailed description of preferred embodiments thereof in coNearest Neighborection with the accompanying drawings.

### BRIEF DESCRIPTION OF THE DRAWINGS

Preferred embodiments according to the present invention will now be described with reference to the Figures, in which like reference numerals denote like elements.

FIG. 1 shows a perspective view of an assembly with a disk-stack assembled on a fixed hub in accordance with one embodiment of the present invention.

FIG. 2(a) shows a perspective view of the automatic clamp in accordance with one embodiment of the present invention.

FIG. 2(b) shows a top view of the automatic clamp in accordance with one embodiment of the present invention.

FIG. 2(c) shows a side view of the automatic clamp in accordance with one embodiment of the present invention.

FIG. 2(d) shows a cross-section view of the automatic clamp in accordance with one embodiment of the present invention.

FIG. 3(a) shows a perspective view of the fixed hub in accordance with one embodiment of the present invention.

FIG. 3(b) shows a cross-section view of the fixed hub in accordance with one embodiment of the present invention.

FIG. 4(a) shows a perspective view of the hub nose in accordance with one embodiment of the present invention.

FIG. 4(b) shows a top view of the hub nose in accordance with one embodiment of the present invention.

FIG. 4(c) shows a cross-section view of the hub nose in accordance with one embodiment of the present invention.

FIG. 5 shows a perspective view of the assembled automatic clamp and fixed hub in accordance with one embodiment of the present invention.

FIG. 6(a) shows a perspective view of the bottom spacer in accordance with one embodiment of the present invention.

FIG. 6(b) shows a cross-section view of the bottom spacer in accordance with one embodiment of the present invention.

FIG. 7(a) shows a perspective view of the clock nut 3 in accordance with one embodiment of the present invention.

FIG. 7(b) shows a cross-section view of the clock nut 3 in accordance with one embodiment of the present invention.

FIG. 8 shows a perspective view of the assembly 1 being mounted onto a spindle in accordance with one embodiment of the present invention.

FIG. 9 shows a cross-section view of the assembly 1 in accordance with one embodiment of the present invention.

FIG. 10(a) shows a perspective view of the spring shaft 81 in accordance with one embodiment of the present invention.

FIG. 10(b) shows a cross section view of the spring shaft 81 in accordance with one embodiment of the present invention.

FIG. 11 shows a perspective view of the servowriter system in accordance with one embodiment of the present invention.

FIG. 12 shows a side view of the servowriter system in accordance with one embodiment of the present invention.

FIG. 13 shows perspective views of the removable spud in accordance with one embodiment of the present invention.

FIG. 14 shows a perspective view of the gripper unit in accordance with one embodiment of the present invention.

FIG. 15(a) shows a perspective view of the gripper fingers in accordance with one embodiment of the present invention.

FIG. 15(b) shows a side view of the gripper fingers in accordance with one embodiment of the present invention.

FIG. 15(c) shows a top view of the gripper fingers in accordance with one embodiment of the present invention.

FIG. 16 shows a plan view of gripper fingers 131 interfacing with the bottom spacer 21 in accordance with one embodiment of the present invention.

FIG. 17 is an exemplary illustration of unloading a disk stack from the fixed hub 7 in accordance with one embodiment of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

In the following detailed description, specific details are set forth in order to provide a thorough understanding of the invention. However, it will be understood by those skilled in the relevant art that the present invention may be practiced without these specific details. In other instances, well-known methods, procedures, components, and materials have not been described in detail so as not to obscure the present invention.

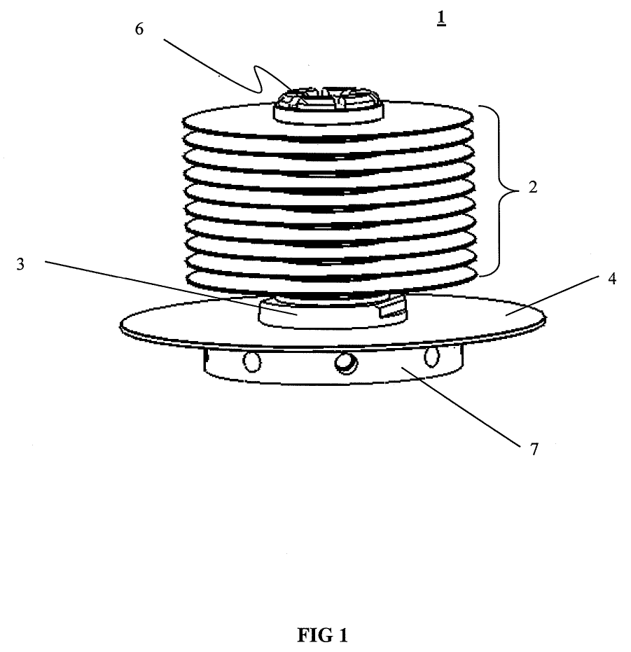

Now referring to FIG. 1, there is provided a perspective view of an assembly with a disk-stack assembled on a fixed hub in accordance with one embodiment of the present invention. The assembly 1 comprises a disk-stack 2 with a plurality of disks and spacers, a clock nut 3, a clock disk 4, an automatic clamp 6, and a fixed hub 7. The fixed hub 7, the automatic clamp 6 and the formation of the assembly will be discussed in detailed hereinafter. The number of the disks within one disk-stack is not limited to any specific one, even though 10 disks are shown in FIG. 1.

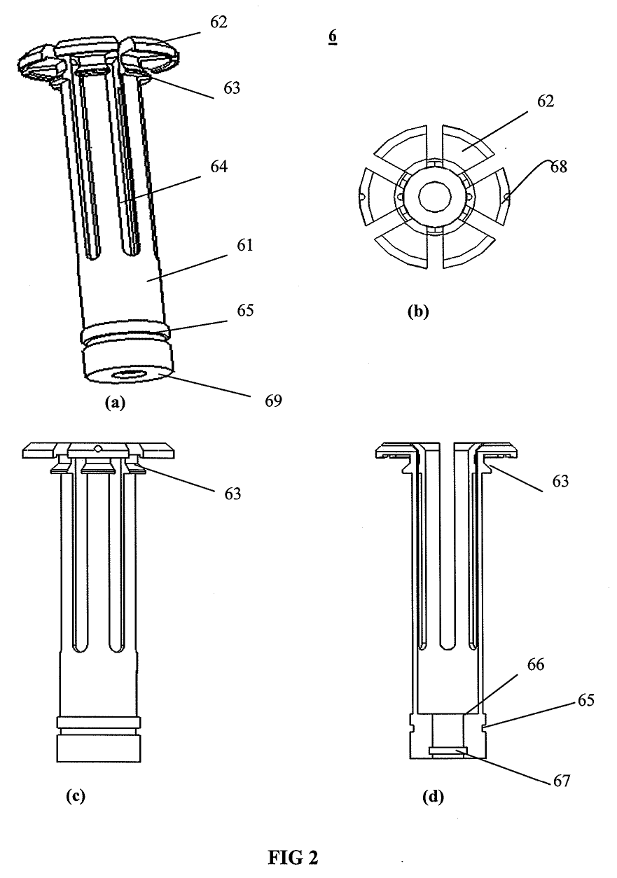

Now referring to FIGS. 2(a)-(d), there are provided more details of the automatic clamp in accordance with one embodiment of the present invention. FIG. 2(a) shows a perspective view of the automatic clamp; FIG. 2(b) a top view; FIG. 2(c) a side view; and FIG. 2(d) a cross-section view. As shown in FIGS. 2(a)-(d), the automatic clamp has a cylindrical body 61, a first end with a plurality of fingers (6 fingers shown) 62 and a ramp 63 for each finger, and a second end with a clamp bottom surface 69 for contacting with the fixed hub, a hub seal groove 65 at the outside and a hard-stop area 66 and a spring shaft seal groove 67 inside of the end; where the cylindrical body 61 has a plurality of slots 64 that are equal to the number of fingers; thus the fingers 62 are flexible to be bent when they ride on the ramp contact with a hub nose (discussed hereinafter). In addition, one or more of the fingers 62 may have a through hole 68 that can be used to verify the clamping force. The length of fingers (controlled by the length of the slots) and the wall thickness of the automatic clamp are not limited to any specific figures; they can be determined by the specific applications. For example, when more disks are used to form a disk stack, the length of the fingers may be increased to provide more flexibility. Any material is suitable for making the automatic clamp if it can achieve desirable yield strength and flexibility. For example, aluminum 7000 series can be used for making the automatic clamp.

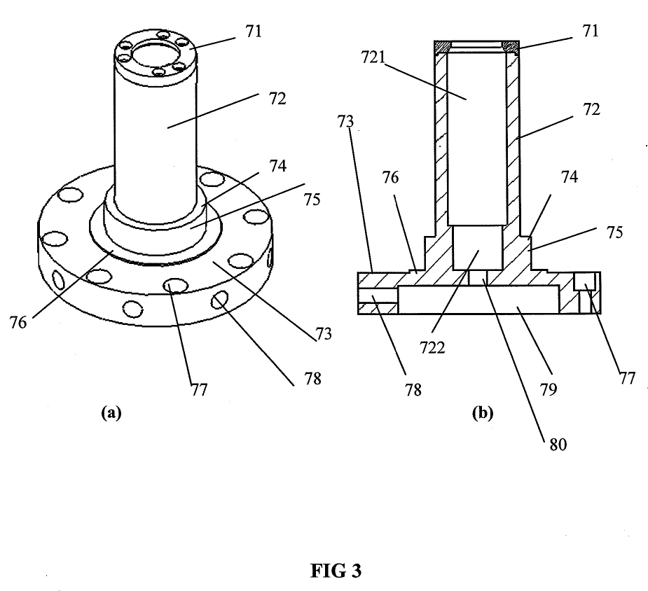

Now referring to FIGS. 3(a)-(b), there are provided more details of the fixed hub in accordance with one embodiment of the present invention. FIG. 3(a) shows a perspective view of the fixed hub; FIG. 3(b) a cross-section view. The fixed hub 7 has a hub nose 71, a hub shaft 72, and a hub base 73. The fixed hub 7 further has a bottom spacer rest shoulder 74, a clock nut thread 75 to secure the clock disk, a clock disk rest shoulder 76, a plurality of mounting holes to spindle 77, and a plurality of balancing holes 78. As shown in FIG. 3(b), the fixed hub has an air chamber 79 for receiving the air from the spindle. The hub shaft 72 is hollow for receiving the automatic clamp 6 within a chamber 721 and an air actuation mechanism 8 (described in detail below) within a chamber 722 and the inner chamber of the automatic clamp.

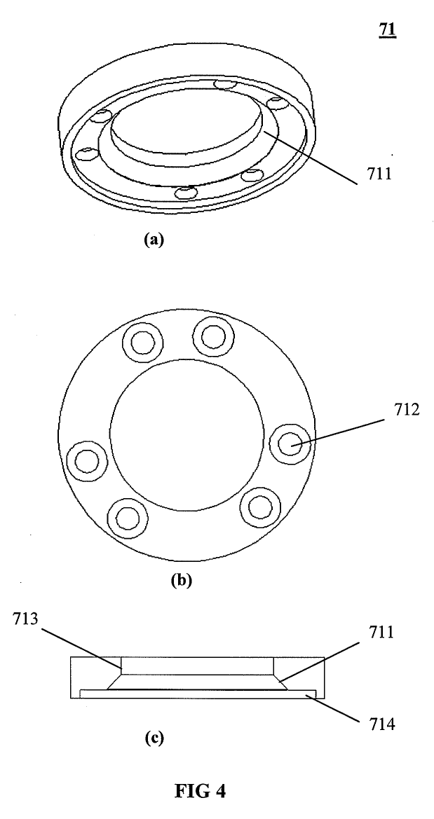

Now referring to FIGS. 4(a)-(c), there are provided more details of the hub nose in accordance with one embodiment of the present invention. FIG. 4(a) shows a perspective view of the hub nose; FIG. 4(b) the top view; and FIG. 4(c) the cross-section view. As shown in FIGS. 4(a)-(c), the hub nose 71 has a circular cap configuration with a ramp 711, a plurality of counter-bore mounting holes (6 holes shown in the drawings) 712 for receiving cap screws to mount the hub nose 71 and the hub shaft 72 together, a re-leave 713 for allowing the clamp to open enabling automatic clamp's fingers to bent without interfering with any components, and a hub locating recession 714. The hub nose 71 has a slight smaller diameter than that of the hub shaft 72. The hub nose 71 is controlled dimension relative to the hub shaft 72. Dimension is preferable to be smaller than fixed hub by 2 mils or less to prevent disk stack contacting the hub nose at the entry and exit points. The hub nose 71 can be mounted onto the hub shaft 72 with a slip fit.

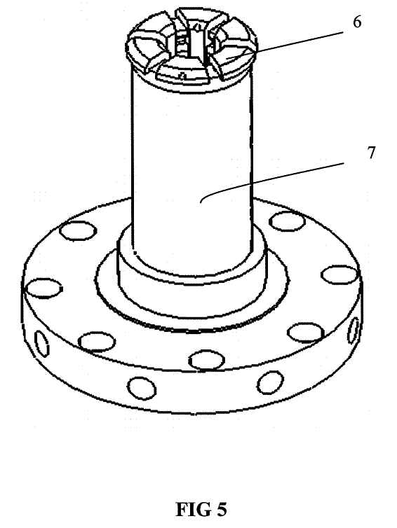

Now referring to FIG. 5, there is provided a perspective view of the assembled automatic clamp and fixed hub in accordance with one embodiment of the present invention.

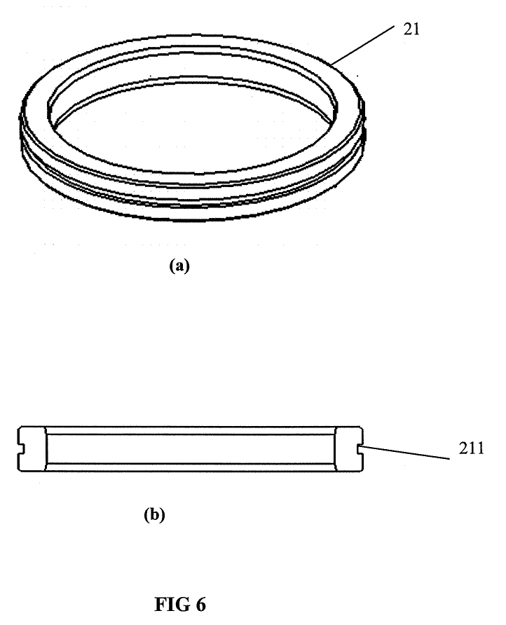

Now referring to FIGS. 6(a)-(b), there are provided more details of the bottom spacer in accordance with one embodiment of the present invention. FIG. 6(a) shows a perspective view of the bottom spacer 21; FIG. 6(b) a cross-section view. As shown in FIGS. 6(a)-(b), the bottom spacer 21 has an outer groove 211 for being used for gripping during the transfer of the disk stack. The bottom spacer 21 may have a chamfer or round configuration of the top and bottom edges. In addition, the bottom spacer 21 should have surface flatness and parallelism of its top and bottom surfaces.

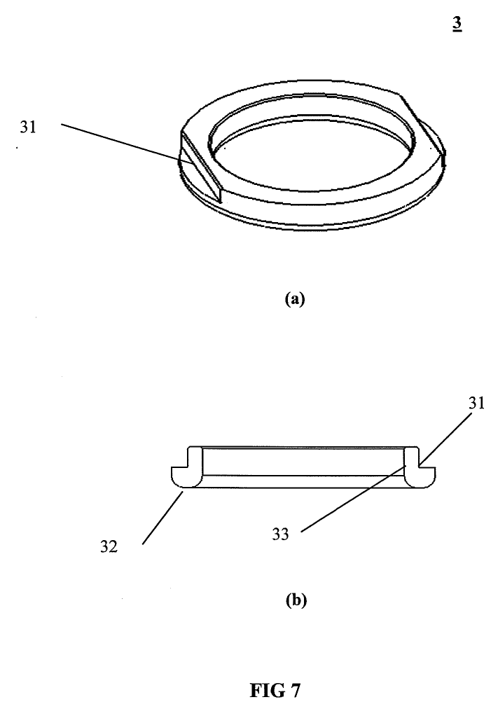

Now referring to FIGS. 7(a)-(b), there are provided more details of the clock nut 3 in accordance with one embodiment of the present invention. FIG. 7(a) shows a perspective view of the clock nut 3; FIG. 7(b) a cross-section view. The clock nut 3 is configured to have a step cut 31 on one side for allowing the use of a tool to tighten the clock disk 4, a clamping surface 32 on the other side, and a threading area 33 on the inner wall. The clamping surface 32 is configured to have roundness at both outer and inner diameters.

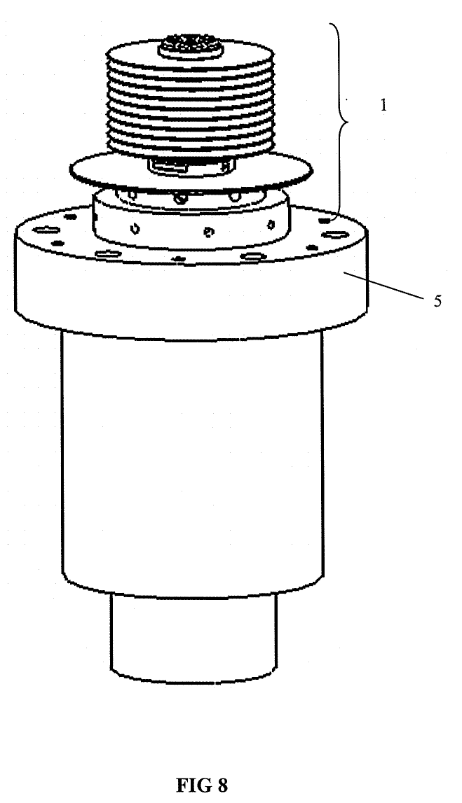

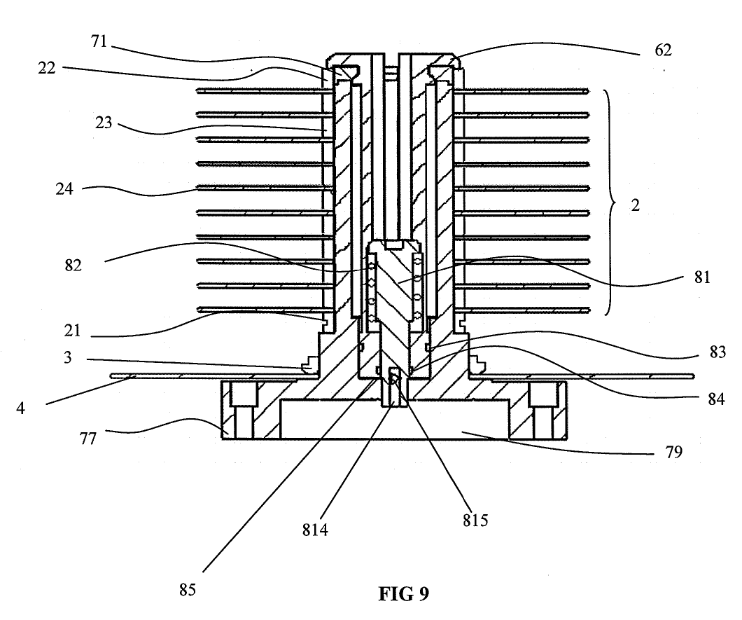

Now referring to FIG. 8, there is provided a perspective view of the assembly 1 being mounted onto a spindle in accordance with one embodiment of the present invention. The spindle 5 is mounted with the assembly 1. Now referring to FIG. 9, there is provided a cross-section view of the assembly 1 in accordance with one embodiment of the present invention. The disk stack 2 comprises a plurality of disks 24, a bottom spacer 21 (details shown in FIGS. 6(a)-(b)), a top spacer 22, and a plurality of middle spacers 23. The fingers 62 of the automatic clamp 6 are denoted herein. The hub nose 71, mounting holes 77, and air chamber 79 of the fixed hub are denoted herein. Disposed within the fixed hub 7 and the automatic clamp 6 is an air actuation mechanism 8 for controlling the automatic clamp 6. The air actuation mechanism 8 comprises a spring shaft 81 (detailed description below), and springs 82. The air actuation mechanism 8 is insulated by an outer seal 83 and an inner seal 84.

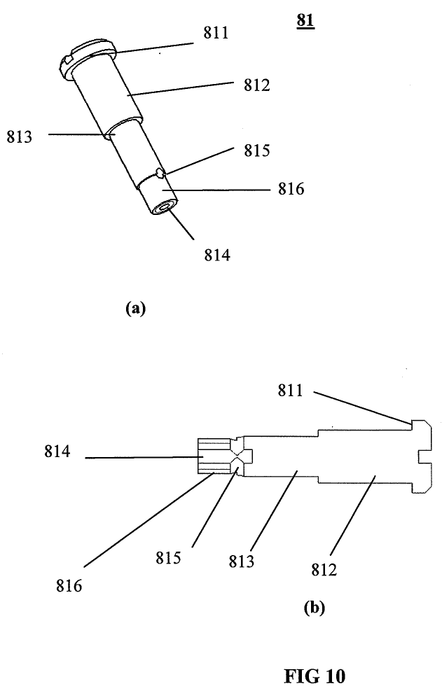

Now referring to FIGS. 10(a)-(b), there are provided more details of the spring shaft 81 in accordance with one embodiment of the present invention. FIG. 10(a) shows a perspective view of the spring shaft 81; FIG. 10(b) a cross section view. The spring shaft 81 has a step-tapered cylindrical configuration that is compatible with the inner chamber of the automatic clamp. The spring shaft 81 has a spring rested shoulder 811, a shaft body 812 for compression spring, a hard-stop shoulder 813 for preventing the automatic clamp 6 from over travel, an air passage 814 communicable with the air chamber 79, and an air outlet 815. The spring shaft 81 further has a male thread 816 secure the spring shaft to the fixed hub 7 via the female thread 80.

Now referring back to FIG. 9, there is provided a more detailed description of the operation of the automatic clamp 6 controlled by the air actuation mechanism 8. Inner chamber/air chamber 79 is to provide intermediate air pocket to activate the automatic clamp 6. The air chamber 79 receives the air supply from the spindle 5 thru the center shaft of the air bearing. The pressurized air from air chamber 79 later passes through the spring shaft inlet 814 and exit at 815 to pressurize the clamp bottom surface 69. A small air gap 85 of approximately 5 to 10 mils is present for pressurization. Since the spring shaft 81 is mounted to fixed hub 7, the automatic clamp 6 is being pushed up by the air gap 85. Automatic clamp 6 will slide on hub body 722 and spring shaft 81. Both components contact with automatic clamp 6 consist of inner and outer seals (83, 84) preventing air from leaking during pressurization. Automatic clamp 6 is similar to the function of single acting air cylinder. When air is released compression spring 82 will hold down the automatic clamp on surface 66. During this stage, disk stack is clamped.

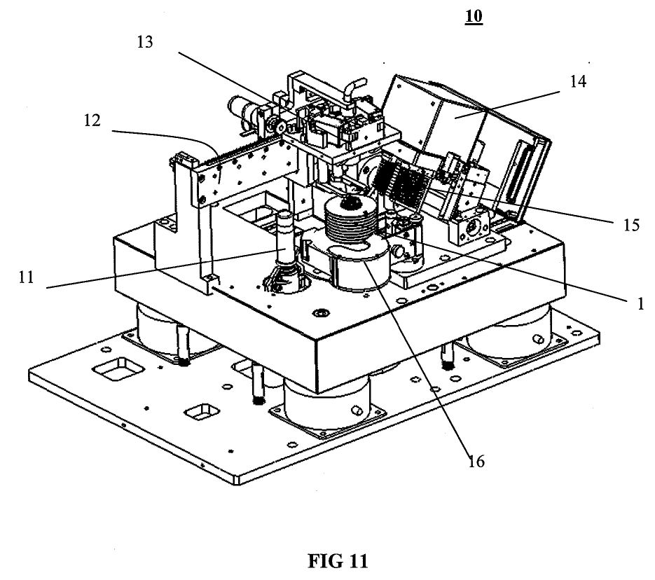

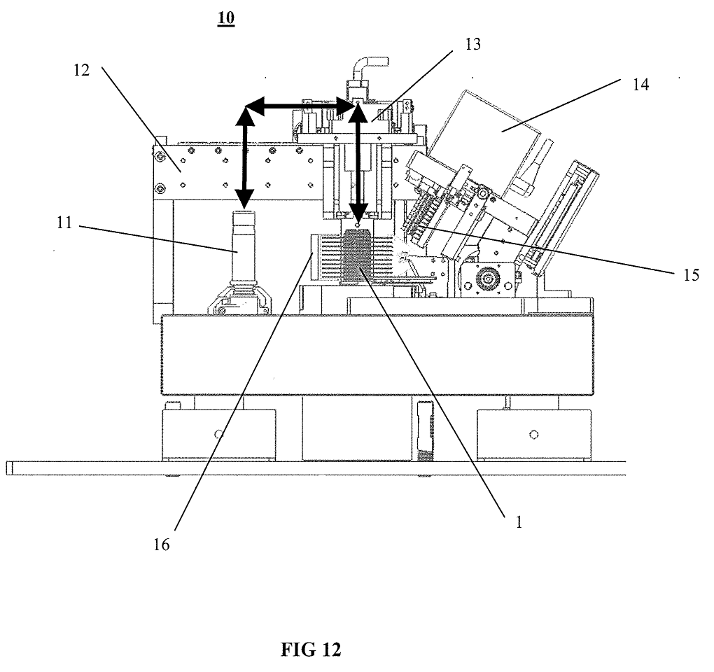

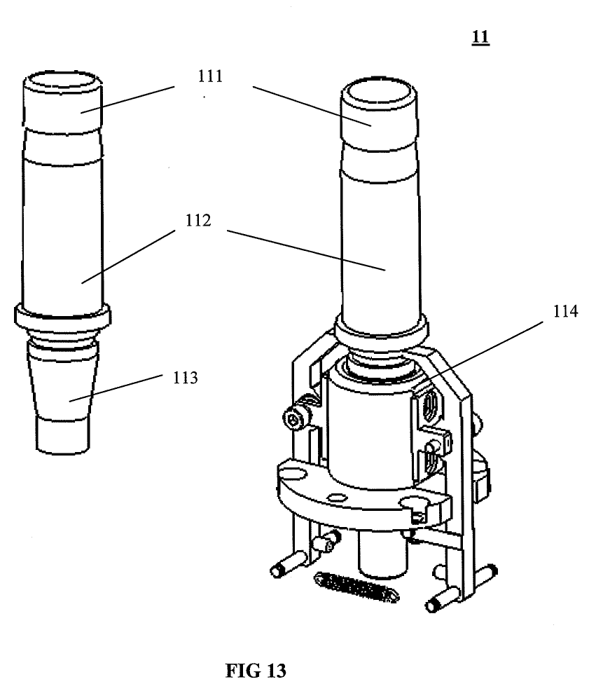

Now referring to FIGS. 11 and 12, there are provided more details of the servowriter system in accordance with one embodiment of the present invention. FIG. 11 shows a perspective view of the servowriter system; FIG. 12 a side view. The servowriter system 10 comprises a removable spud 11, a transporter unit 12, a gripper unit 13, a positioner 14, an E-block 15, and a fixed hub 7. As shown in FIG. 11, the fixed hub has been mounted with a disk stack; thus an assembly 1 is shown. The removable spud 11 is configured to allow stacking/destacking disks offline. The gripper unit 13 has a design to carry an assembled disk stack from the removable spud to the fixed hub or vice versa. The positioner 14 is capable of rotation and movement so that the E-block can be moved away from the fixed hub and moved aside when a disk stack is loaded/unloaded from the fixed hub. The E-block (mount with multiple head arms) is the head arm actuator for allowing the servowriting process to be performed. The servowriter system 10 further comprises an air damper 16 for reducing the vibration of the servowriter during the servowriting process. The transporter unit 12 transfers the disk stack 2 from the removable hub 11 (shown in FIG. 13)) by moving in the path as shown on FIG. 12 to the fixed hub 7 or vice versa. When the gripper unit 13 moves down to grip the disk stack 2 from the removable hub 11, the automatic clamp 111 will open to allow the disk stack to be lifted up without hitting. The gripper unit 13 will follow the path as shown in FIG. 12 and load the disk stack to the fixed hub 7. During this motion, both automatic clamps 111 and 6 are open. When the gripper unit 13 moves down to load the disk stack and move away, the automatic clamp 6 at the fixed hub will close to clamp the disk stack before servo-written disk begin. This process will proceed when unloading the disk stack from the fixed hub 7 back to the removable spud 11.

Now referring to FIG. 13, there is provided perspective views of the removable spud in accordance with one embodiment of the present invention. The removable spud 11 is configured to have an automatic clamp 111 for holding the assembled disk stack in place; a body 112 for disk assembly; and an interface portion 113 for positioning the removable spud. The automatic clamp 111 has an identical design and configuration of the automatic clamp 6 described above. As shown in FIG. 13, a clamping mechanism 114 is provided so that the removable spud can be released from the clamping mechanism.

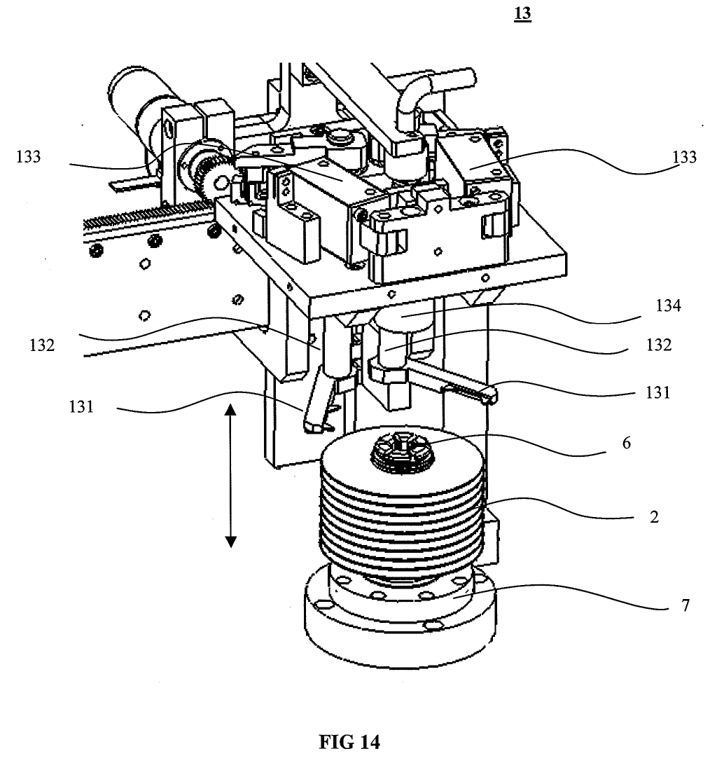

Now referring to FIG. 14, there is provided a perspective view of the gripper unit in accordance with one embodiment of the present invention. The gripper unit 13 is integrally connected with the transporter unit 12 so that the gripper unit 13 can be moved from the removable spud to the fixed hub or vice versa. In addition, the gripper unit 13 can be positioned over the removable spud and the fixed hub to grip and hold the disk stack so that the vertical motion (as shown by the arrow) of the gripper unit 13 enables it to mount and unload the disk stack. The gripper unit 13 comprises a pair of gripper fingers 131, a pair of gripper connecting rods 132, a pair of actuation cylinders 133, and a disk stack holder 134. The gripper connecting rods 132 integrally connect the gripper fingers 131 and the actuation cylinders 133 so that the grippers fingers can be controlled by the actuation cylinders.

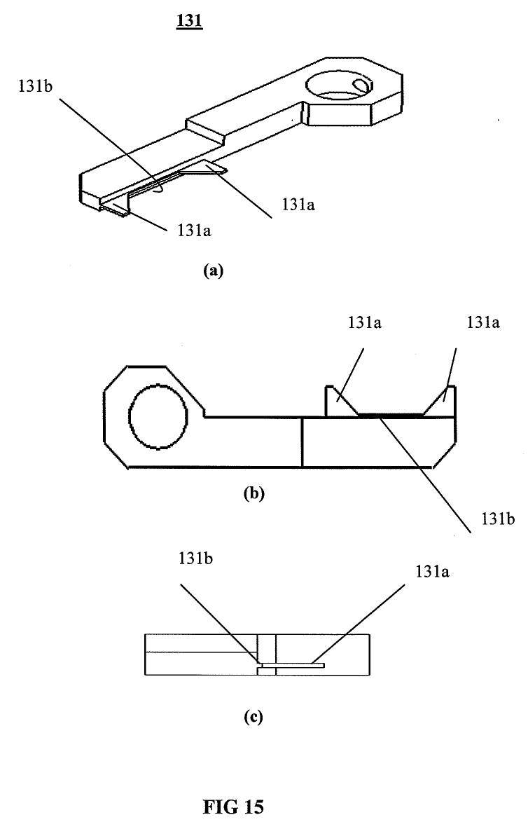

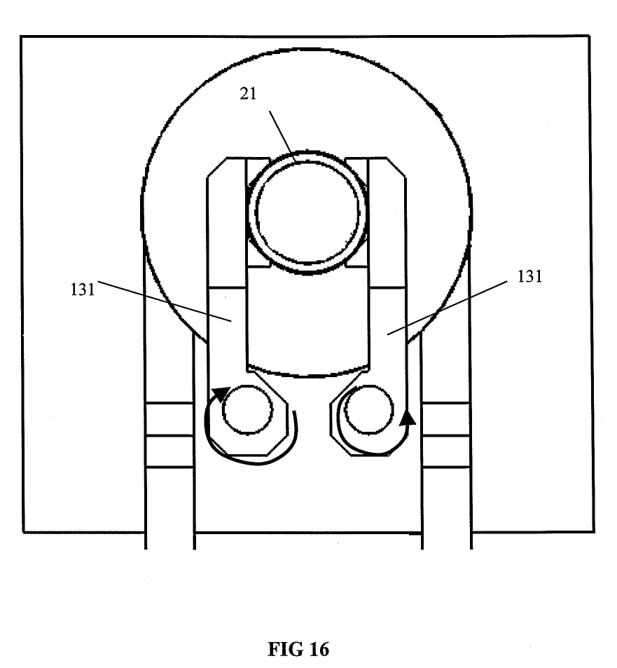

Now referring to FIGS. 15(a)-(c), there are provided more details of the gripper fingers in accordance with one embodiment of the present invention. FIG. 15(a) shows a perspective view of the gripper fingers 131; FIG. 15(b) a side view; and FIG. 15(c) a top view from the gripping tips 131a. The gripper finger comprises a pair of gripping tips 131a and a gripping guide 131b, where when the gripper fingers 131 are guided by its gripping guide 131b to its proper position, and then the gripping tips 131a will grip the bottom space 21 via the gripping groove 211. As shown in FIG. 16, there is provided a plan view of gripper fingers 131 interfacing with the bottom spacer 21, where the arrows show the movements of the gripper fingers.

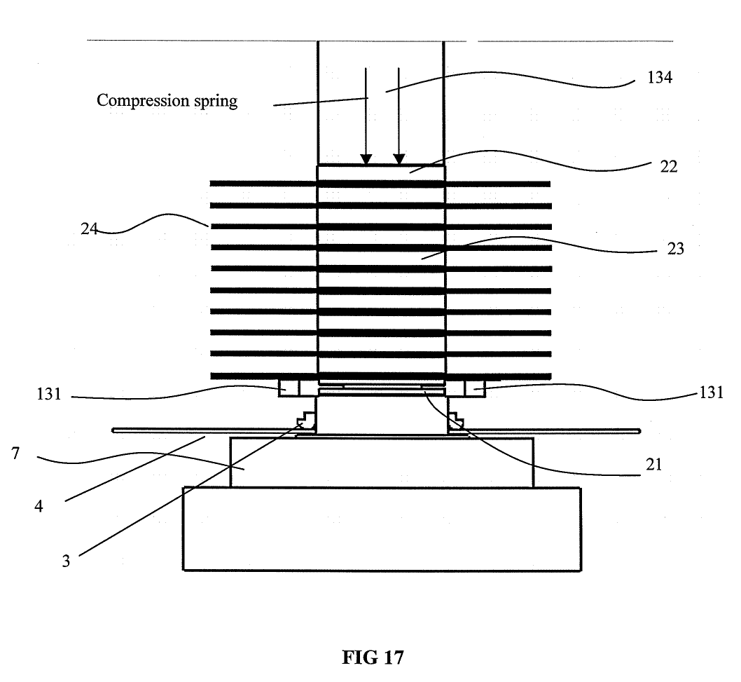

Now referring to FIG. 17, there is provided an exemplary illustration of unloading a disk stack from the fixed hub 7 in accordance with one embodiment of the present invention. When the disk stack is unloaded from fixed hub 7, the gripper unit 13 will move down to unloading position. At the unloading position, the disk stack holder 134 will contact with the disk stack top spacer 22. At this moment, the disk stack 2 is being compressed by the disk stack holder 134. The design of the disk stack holder 134 is guided and being compressed by the spring (indicated by arrows). The gripper fingers 131 (FIG. 16) will grip the bottom spacer 21 when the gripper rested on the hardstop. However hardstop positions are adjustable for fine tuning. When the bottom spacer is gripped by fingers 131, the disk stack 2 can be removed from the fixed hub 7.

Now there is provided a brief description of loading a disk stack from the removable spud 11 to the fixed hub 7. Initially, the gripper unit 13 is positioned over the removable spud 11 controlled by the transporter unit 12; the spindle 5 at stop position; the positioner 14 at open position; and the removable spud 11 is held by the mechanic clamp 114. Then, the disk stack 2 including the bottom spacer and top spacer is assembled onto the removable spud; then the automatic clamps 6, 111 are at open position; then, the gripper unit 13 moves down to a gripping position so that the fingers 131 grip the bottom spacer 21 and the disk stack holder 134 compresses the top spacer 22; then the gripper unit 13 is transported to the fixed hub 7 following the arrow path as shown in FIG. 12. At the fixed hub position, the gripper unit 13 lowers down until the bottom spacer 21 rests on the rest shoulder; then the fingers move away from the bottom spacer and the disk stack holder moves away from the top spacer. Then, the automatic clamp 6 closes; the positioner 14 closes; the E-block 15 loads; and the servowriter is ready for processing. The unloading of a disk stack from the fixed hub to the removable spud is a reverse process of the loading, so that no more detailed description is necessary.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A disk stack assembly for processing a plurality of disks in a servowriter, said disk stack assembly comprising:
a disk-stack with a plurality of disks and spacers, where the disks and spacers are alternately placed, and a bottom spacer and a top spacer are disposed at the two ends of the disk stack;
a fixed hub upon which the disk stack is mounted for processing, where the fixed hub has a central chamber; and
an automatic clamp disposed within the central chamber;
thereby when the disk stack is mounted onto the fixed hub, the automatic clamp clamps the disk stack to secure the disk stack through the processing.

2. The disk stack assembly of claim 1, further comprising
a clock nut; and
a clock disk secured by the clock nut; where the clock nut and the clock disk are disposed below the bottom spacer.

3. The disk stack assembly of claim 1, wherein the automatic clamp is configured to have:
a cylindrical body with a first end and a second end;
where a first end with a plurality of fingers, where each finger has a ramp;
where a second end with a clamp bottom surface for contacting with the fixed hub, a hub seal groove at the outside of the second end, and a hard-stop area and a spring shaft seal groove inside of the second end; and
where the cylindrical body has a plurality of slots that are equal to the number of fingers; thus the fingers are flexible to be bent when they ride on the ramp.

4. The disk stack assembly of claim 3, said disk stack assembly further comprising:
an air actuation mechanism for controlling the open/close switch of the automatic clamp.

5. The disk stack assembly of claim 4, wherein the spring shaft has a spring rested shoulder, a shaft body for compression spring, a hard-stop shoulder for preventing the automatic clamp from over travel, an air passage communicable with the external pressurized air supply, an air outlet and a male thread to secure the spring shaft to the hub.

6. The disk stack assembly of claim 1, wherein the fixed hub has:
a hub nose;
a hub shaft; and
a hub base;
wherein the hub nose is configured to have a smaller dimension that that of the hub shaft to reduce the contact of the disks with the fixed hub;
wherein the hub shaft is configured to have a central hollow for receiving the automatic clamp and allowing the communication of the automatic clamp with an external actuation mechanism; and
wherein the hub base is configured to receive the disk stack and other additional components.

7. A servowriter system for processing multiple disks, said servowriter system comprising:
an offline stacking/destacking module for assembling or disassembling a disk stack with a plurality of disks and spacers;
a fixed hub upon which a disk stack assembly is assembled for processing;
a gripper module for holding the disk stack during transport; and
a transporter module operably connected to the gripper module so that the disk stack can be transported from the offline stacking/destacking module to the fixed hub or vice versa.

8. The servowriter system of claim 7, further comprising:
an E-block for providing actuating arms for read/write heads; and
a positioner for positioning the E-block onto the disk stack from the fixed hub when the processing is ready.

9. The servowriter system of claim 7, wherein the offline stacking/destacking module comprises:
a removable spud that is configured to have an automatic clamp for holding the assembled disk stack in place; a body for disk assembly; and an interface portion for positioning the removable spud;
an automatic clamp for clamping the assembled disk stack; and
a clamping mechanism for holding and positioning the removable spud.

10. The servowriter system of claim 7, wherein the disk stack assembly comprising:
the disk-stack with a plurality of disks and spacers, where the disks and spacers are alternately placed, and a bottom spacer and a top spacer are disposed at the two ends of the disk stack;
the fixed hub upon which the disk stack is mounted for processing, where the fixed hub has a central chamber; and
an automatic clamp disposed within the central chamber;
thereby when the disk stack is mounted onto the fixed hub, the automatic clamp clamps the disk stack to secure the disk stack through the processing.

11. The servowriter system of claim 10, wherein the disk stack assembly further comprises:
a clock nut; and
a clock disk secured by the clock nut; where the clock nut and the clock disk are disposed below the bottom spacer.

12. The servowriter system of claim 10, wherein the automatic clamp is configured to have:
a cylindrical body with a first end and a second end;
where a first end with a plurality of fingers, where each finger has a ramp;
where a second end with a clamp bottom surface for contacting with the fixed hub, a hub seal groove at the outside of the second end, and a hard-stop area and a spring shaft seal groove inside of the second end; and
where the cylindrical body has a plurality of slots that are equal to the number of fingers; thus the fingers are flexible to be bent when they ride on the ramp.

13. The servowriter system of claim 12, wherein said disk stack assembly further comprises:
an air actuation mechanism for controlling the open/close switch of the automatic clamp.

14. The servowriter system of claim 13, wherein the spring shaft has a spring rested shoulder, a shaft body for compression spring, a hard-stop shoulder for preventing the automatic clamp from over travel, an air passage communicable with the external pressurized air supply, and an air outlet and a male thread to secure the spring shaft to the hub.

15. The servowriter system of claim 14, wherein the fixed hub has:
a hub nose;
a hub shaft; and
a hub base;
wherein the hub nose is configured to have a smaller dimension that that of the hub shaft to reduce the contact of the disks with the fixed hub;
wherein the hub shaft is configured to have a central hollow for receiving the automatic clamp and allowing the communication of the automatic clamp with an external actuation mechanism; and
wherein the hub base is configured to receive the disk stack and other additional components.

16. The servowriter system of claim 10, wherein the bottom spacer has an outer groove for being used for gripping during the transport of the disk stack.

17. The servowriter system of claim 7, wherein the gripper module comprises a pair of gripper fingers, a pair of gripper connecting rods, a pair of actuation cylinders, and a disk stack holder; where the gripper connecting rods integrally connect the gripper fingers and the actuation cylinders so that the grippers fingers can be controlled by the actuation cylinders.

18. The servowriter system of claim 17, wherein the gripper finger comprises a pair of gripping tips and a gripping guide.

19. The servowriter system of claim 7, further comprising an air damper for reducing the vibration of the system.
